(19) United States
(12) Patent Application Publication
(10) Pub. No.: US 2021/0181431 A1
(43) Pub. Date: Jun. 17, 2021

(54) OPTICAL CONNECTING COMPONENT

(71) Applicant: SUMITOMO ELECTRIC INDUSTRIES, LTD., Osaka (JP)

(72) Inventor: Yasuomi KANEUCHI, Osaka-shi (JP)

(73) Assignee: SUMITOMO ELECTRIC INDUSTRIES, LTD., Osaka (JP)

(21) Appl. No.: 17/188,113

(22) Filed: Mar. 1, 2021

Related U.S. Application Data
(63) Continuation of application No. PCT/JP2019/033127, filed on Aug. 23, 2019.

(30) Foreign Application Priority Data
Aug. 27, 2018 (JP) 2018-158778

(51) Int. Cl. G02B 6/36

(52) U.S. Cl. CPC G02B 6/3636

(57) ABSTRACT

An optical connecting component includes: an optical fiber; a first fixing member to which one end portion of the optical fiber is fixed; and a second fixing member including a bendable middle bone, a grip portion for griping the first fixing member on one end side of the middle bone, and an optical fiber fixing portion for fixing the optical fiber to the middle bone on the other end side of the middle bone.

### CROSS-REFERENCE TO RELATED APPLICATION(S)

This application is a continuation of PCT application No. PCT/IP2019/033127, which was filed on Aug. 23, 2019 based on Japanese Patent Application No. 2018-158778 filed on Aug 27, 2018, the contents of which are incorporated herein by reference.

### TECHNICAL FIELD

The present disclosure relates to an optical connecting component.

### BACKGROUND ART

As an optical module is miniaturized, when one end portion of an optical fiber is vertically and oppositely spliced to a circuit board on which an optical element such as a light emitting element, a light receiving element, and an optical circuit is mounted, it is required to reduce a height of an optical connecting component so as to keep a height of the optical fiber from the circuit board low. In order to reduce the height of the optical connecting component, it is necessary to bend a vicinity of a tip of the optical fiber with a small radius. Therefore, Patent Literature 1 discloses an optical path conversion member in which a plurality of aligned positioning grooves are formed on an upper side surface of a base circuit board having a curved tip surface that smoothly continues from a flat upper surface, and a lid member having a surface along the upper side surface of the base circuit board is provided for pressing the optical fiber housed in the positioning groove of the base circuit board. Patent Literature 2 discloses an optical connector in which the optical fiber is curved by forming a curved hole in a connector body and by inserting and fixing the optical fiber in the hole.

### CITATION LIST

### Patent Literature

Patent Literature 1: IP-A-2008-52028

Patent Literature 2: JP-A-2007-156006

### SUMMARY OF INVENTION

An optical connecting component according to one aspect of the present disclosure includes: an optical fiber; a first fixing member to which one end portion of the optical fiber is fixed; and a second fixing member including a bendable middle bone (backbone), a grip portion for griping the first fixing member on one end side of the middle bone, and an optical fiber fixing portion for fixing the optical fiber to the middle bone on the other end side of the middle bone.

### BRIEF DESCRIPTION OF DRAWINGS

FIG. 1A is a front view illustrating an example of an optical fiber provided in an optical connecting component of the present disclosure.

FIG. 1B is a side view illustrating the optical fiber of FIG. 1A.

FIG. 2A is a front view illustrating an example of a first fixing member provided in the optical connecting component of the present disclosure in a state where the optical fiber is fixed thereto.

FIG. 2B is a plan view illustrating the first fixing member of FIG. 2A in the state where the optical fiber is fixed thereto.

FIG. 2C is a front view illustrating another example of the first fixing member provided in the optical connecting component of the present disclosure in a state where the optical fiber is fixed thereto.

FIG. 2D is a plan view illustrating another example of the first fixing member of FIG. 2C in a state where the optical fiber is fixed thereto.

FIG. 3A is a perspective view illustrating an example of a second fixing member of the optical connecting component of the present disclosure.

FIG. 3B is a front view of the second fixing member illustrated in FIG. 3A.

FIG. 3C is a side view of the second fixing member illustrated in FIG. 3A.

FIG. 4A is a cross-sectional view illustrating an example in which the first fixing member is mounted on the second fixing member of FIG. 3A in a state where the second fixing member is not bent.

FIG. 4B is a cross-sectional view illustrating an example in which the first fixing member is mounted on the second fixing member of FIG. 3A in a state where the second fixing member is bent.

FIG. 5 is a perspective view illustrating another example of the second fixing member of the optical connecting component of the present disclosure.

### DESCRIPTION OF EMBODIMENTS

### Technical Problem

The optical path conversion member disclosed in Patent Literature 1 or the optical connector disclosed in Patent Literature 2 is required to include a circuit board having a predetermined curved surface or a connector body having a curved hole in order to bend the optical fiber to a desired radius and angle, and is required to change the circuit board and the connector body when changing a curvature of the optical fiber. The present disclosure provides an optical connecting component capable of bending and holding an optical fiber with any curvature without requiring a circuit board having a predetermined curved surface or a connector member having a curved hole.

### Description of Embodiments of the Present Disclosure

First, embodiments of the present disclosure will be listed and described.

(1) An optical connecting component according to one aspect of the present disclosure includes: an optical fiber; a first fixing member to which one end portion of the optical fiber is fixed; and a second fixing member including a bendable middle bone (backbone), a grip portion for griping the first fixing member on one end side of the middle bone, and an optical fiber fixing portion for fixing the optical fiber to the middle bone on the other end side of the middle bone.

According to the above-described configuration, the middle bone of the second fixing member is bent, thereby making it possible to obtain the optical connecting component capable of bending and holding the optical fiber with any curvature without requiring a circuit board having a predetermined curved surface or a member having a curved hole.

(2) The mid bone may be bent, and the optical fiber may be bent along the middle bone. According to the above-described configuration, the first fixing member is mounted on the second fixing member in which the middle bone is bent to any curvature and shape in advance, and the optical fiber is fixed along the middle bone, thereby making it possible to obtain the optical connecting component that bends and holds the optical fiber.

(3) The first fixing member may include a hole through which the one end portion of the optical fiber penetrates, and (4) the first fixing member may include two plate-shaped members that sandwich the one end portion of the optical fiber. According to the above-described configuration, a plurality of configurations can be selected as the first fixing member.

(5) The optical fiber fixing portion may be a clamp member that is provided on the middle bone and clamps the optical fiber, and (6) the optical fiber fixing portion may be an adhesive that allows the optical fiber to adhere to the middle bone. According to the above-described configuration, various methods can be adopted as a method for fixing the optical fiber to the middle bone of the second fixing member. (7) The second fixing member may be made of plastically deformable steel material. According to the above-described configuration, the second fixing member can be easily manufactured by punching and bending.

### Details of Embodiments of the Present Disclosure

Hereinafter, a desirable embodiment according to an optical connecting component of the present disclosure will be described with reference to the drawings. In the following description, since a configuration denoted by the same reference sign even in a different drawing is regarded as the same configuration, the description thereof may be omitted. The present invention is not limited to examples in these embodiments, and includes all the modifications within the scope of matters described in the scope of the claims and within the scope equivalent thereto. As long as a combination of a plurality of embodiments can be performed, the present invention includes a combination of any embodiments.

### First Embodiment

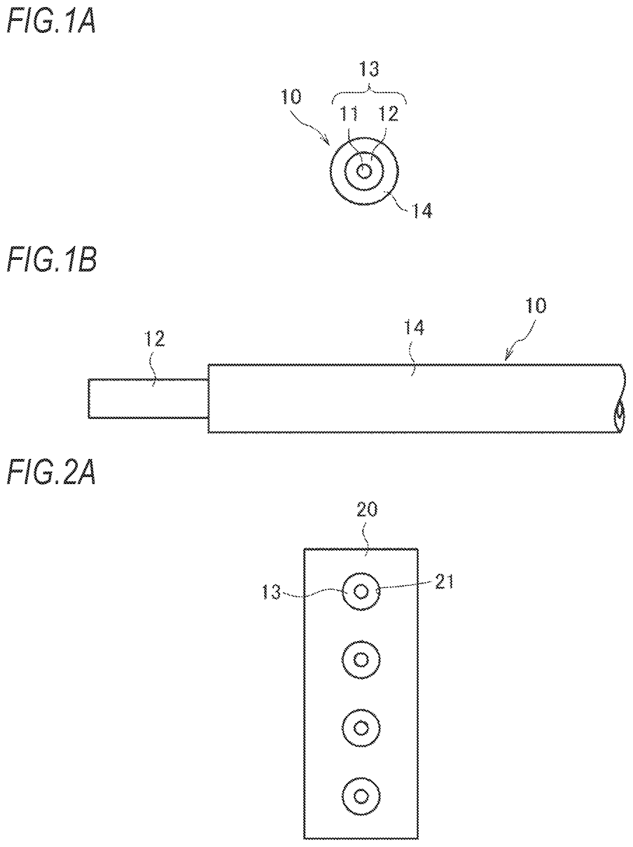

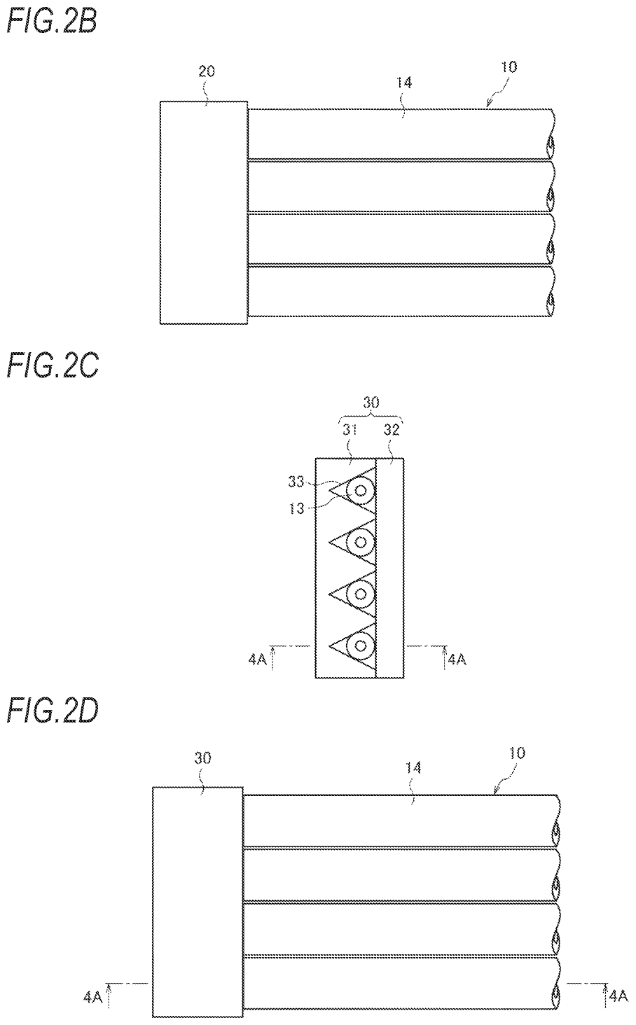

FIGS. 1A and 1B are a front view and a side view illustrating an example of an optical fiber used in a splicing component of the present disclosure, respectively. FIGS. 2A and 2B are a front view and a side view illustrating an example of a first fixing member provided in the optical connecting component of the present disclosure in a state where the optical fiber is fixed thereto, respectively. An optical fiber 10 includes: at least one core 11 made of quartz glass; a clad 12 that is provided around a periphery of the core 11 and has a refractive index lower than that of the core 11; and a resin coating layer 14 covering a periphery of the clad 12. The glass core 11 and the clad 12 form a glass fiber 13.

As illustrated in FIGS. 2A and 2B, for example, one end portions of four optical fibers 10 are fixed to a first fixing member 20. In the embodiment, as illustrated in FIG. 1, the coating layer 14 at one end portion of the optical fiber 10 is stripped, the clad 12 of the glass fiber 13 is exposed, and the exposed glass fiber 13 is fixed to the first fixing member 20. The first fixing member 20 is a member for aligning the optical fibers 10, and is an approximately rectangular parallelepiped glass capillary member including pores 21. An inner diameter of the pore 21 is slightly larger than an outer diameter of the glass fiber 13, and when the glass fiber 13 is inserted into the pore 21, the glass fiber 13 is loosely fitted and positioned so as to be movable back and forth. The first fixing member 20 and the glass fiber 13 are fixed to each other by filling a gap between the pore 21 and the glass fiber 13 with an adhesive by using a capillary phenomenon.

FIGS. 2C and 2D are a front view and a side view illustrating another example of the first fixing member provided in the optical connecting component of the present disclosure in a state where the optical fiber is fixed thereto, respectively. A first fixing member 30 is formed of a V-groove circuit board 31 made of glass and a flat circuit board 32 also made of glass. The V-groove circuit board 31 includes, for example, four V-grooves 33 arranged in parallel, and each V-groove 33 has a size in which the glass fiber 13 can be placed. The flat circuit board 32 has a size that covers the respective V-grooves 33 of the V-groove circuit board 31 and has a flat shape. The glass fiber 13 is placed on each V-groove 33 of the V-groove circuit board 31, and is covered with the flat circuit board 32. The flat circuit board 32 is fixed to the V-groove circuit board 31 together with the glass fiber 13 with an adhesive. The first fixing member 30 including the V-groove circuit board 31 and the flat circuit board 32 has an approximately rectangular parallelepiped shape which is similar to that of the first fixing member 20.

The optical fiber 10 fixed to the first fixing members 20 and 30 may be one or a plurality of optical fibers other than four, and may be an optical fiber ribbon formed by taping a plurality of optical fibers 10 arranged in parallel with a common coating. The optical fiber 10 may include a single core or a plurality of cores. Tips of the first fixing members 20 and 30 to which the optical fiber 10 is fixed are polished together with the glass fiber 13, and are fixed to a circuit board on which an optical element is mounted, which is not illustrated, by, for example, an adhesive. Materials of the first fixing members 20 and 30 are desirably glass from a viewpoint of matching a coefficient of thermal expansion with the glass fiber 13, and may be resin.

When the optical fiber 10 is fixed to the first fixing members 20 and 30, the glass fiber 13 is exposed and fixed to the first fixing members 20 and 30, and may be fixed thereto in a state where the coating layer 14 is provided thereon. Therefore, in the present disclosure, the term “optical fiber” indicates an optical fiber in which the coating layer is provided on the glass fiber, and also includes an optical fiber in which the coating layer is partially stripped and the glass fiber is exposed. In the embodiment, the first fixing members 20 and 30 are provided on one end side of the optical fiber 10, and the above-described first fixing members 20 and 30 may be also mounted on the other end side of the optical fiber 10 and a tip thereof may be polished.

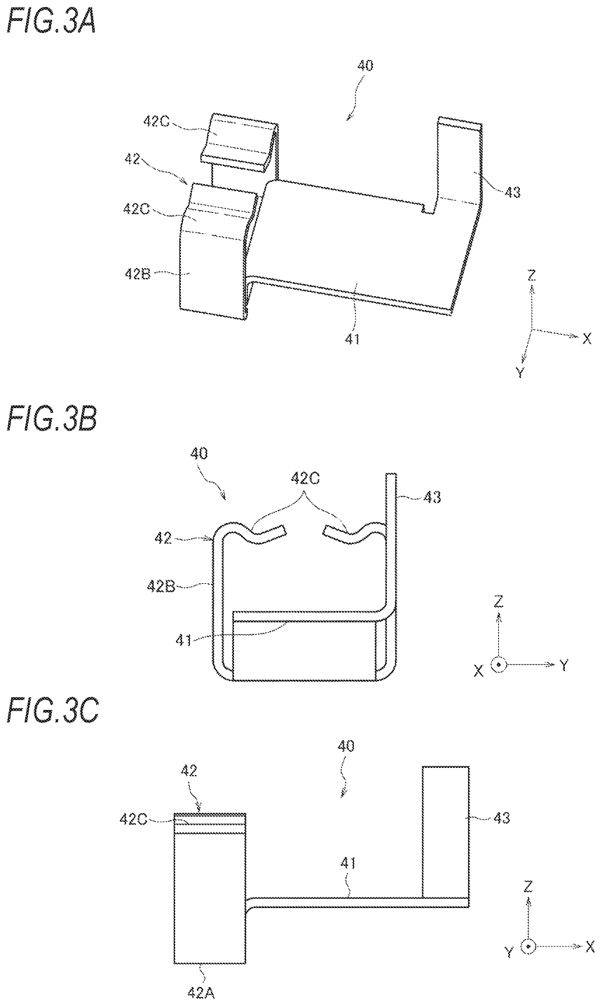

FIG. 3A is a perspective view illustrating an example 40 of the second fixing member of the optical connecting component of the present disclosure. FIG. 3B is a plan view of the second fixing member 40, and FIG. 3C is a side view of the second fixing member 40. The second fixing member 40 is a member for bending the optical fiber 10 to any curvature, the first fixing member 20 to which the optical fiber 10 is fixed (alternatively, the first fixing member 30 may be used. Hereinafter, the first fixing member 20 will be described as an example.) is mounted on one end side thereof, and the optical fiber 10 itself is fixed to the other end side thereof.

As illustrated in FIG. 3A, the second fixing member 40 includes: a bendable middle bone (backbone) 41 extending in the X-axis direction; a grip portion 42 provided at one end of the middle bone 41; and an optical fiber clamp piece 43 serving as an optical fiber fixing portion provided on the other end side of the middle bone 41. The second fixing member 40 is made of a plastically deformable steel material such as stainless steel, and, for example, is obtained by punching and bending one stainless steel plate. A thickness of the second fixing member 40 is desirably equal to or greater than 0.2 mm from a viewpoint of predetermined intensity and ease of processing.

The grip portion 42 includes: a bottom side portion 42A connected from the middle bone 41 and parallel to the middle bone 41; two side wall portions 42B extending vertically from the bottom side portion 42A with a predetermined space therebetween; and two upper side portions 42C that are respectively connected to the two side wall portions 42B and opposite to the bottom side portion 42A, and has an approximately square shape in a YZ cross section. When the rectangular parallelepiped first fixing member 20 is mounted on the grip portion 42, the upper side portion 42C is bent so as to act as a leaf spring so that the bottom side portion 42A and the upper side portion 42C elastically hold the first fixing member 20 from a Z-axis direction. When the first fixing member 20 is mounted thereon, heights of the middle bone 41 and the bottom side portion 42A are adjusted so that the optical fiber 10 is located on the middle bone 41. in the embodiment, when the rectangular parallelepiped first fixing member 20 is mounted on the grip portion 42, the first fixing member 20 is configured to be elastically held from the Z-axis direction, and the first fixing member 20 may be configured to be elastically held from a Y-axis direction by deforming the two side wall portions 42B.

The middle bone 41 allows the optical fiber 10 to be bent along the optical fiber 10 in a longitudinal direction (X-axis direction). The other end portion of the middle bone 41 on a side opposite to the grip portion 42 serves as an optical fiber fixing portion for fixing the optical fiber 10. In the embodiment, in order to fix the optical fiber 10, the optical fiber clamp piece 43 that is punched with the middle bone 41 in an integrated manner and bent in the Z-axis direction is provided at the other end portion of the middle bone 41. The optical fiber 10 is fixed to the middle bone 41 at the optical fiber fixing portion so that the optical fiber 10 is bent along the middle bone 41 when the middle bone 41 is bent. In order to fix the optical fiber 10 at the optical fiber fixing portion on the other end side of the middle bone 41, in addition to using the optical fiber clamp piece 43, for example, a clip member configured separately from the middle bone 41 may be used, or an adhesive may be used.

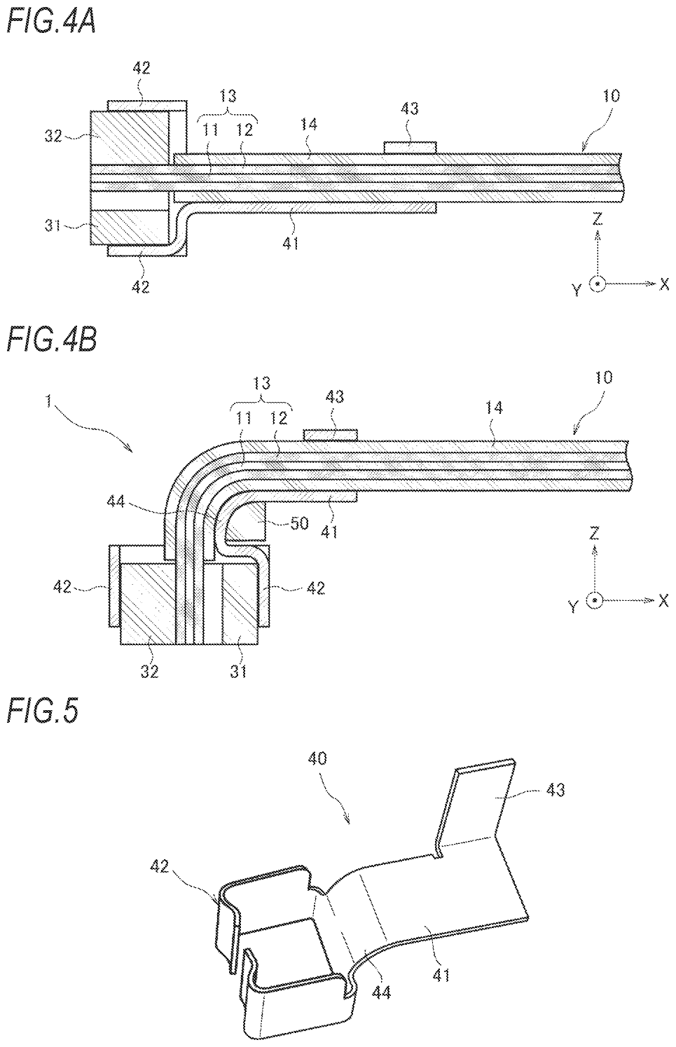

Next, a method for manufacturing the optical connecting component by using the first fixing member 20 and the second fixing member 40 will be described. FIG. 4A is a cross-sectional view illustrating an example in which the first fixing member is mounted on the second fixing member in a state where the second fixing member is not bent, and FIG. 4B is a cross-sectional view illustrating an example in which the first fixing member is mounted on the second fixing member in a state where the second fixing member is bent. FIGS. 4A and 4B illustrate a cross section of the optical fiber 10 and the first fixing member 20 taken along the line 4A-4A of FIG. 2D. The first fixing member 20 to which the optical fiber 10 is fixed is inserted into the second fixing member 40 from a minus side in the X-axis direction, the first fixing member 20 is fixed by the grip portion 42 of the second fixing member 40, and the optical fiber 10 is placed along the middle bone 41. Next, the optical fiber clamp piece 43 provided at the other end portion of the middle bone 41 is bent toward the middle bone 41, and the optical fiber 10 is fixed at the other end side of the middle bone 41. As described above, as a method for fixing the optical fiber 10 to the other end side of the middle bone 41, a separate clip member and an adhesive may be used.

Next, as illustrated in FIG. 4B, an optical connecting component 1 is obtained by applying an external force in a normal direction of the middle bone 41 and deforming the middle bone 41 into a desired circular arc shape to form a bent portion 44 in the middle bone 41, At that time, for example, it is desirable to use a rod-shaped jig 50 including a circular arc portion of a predetermined curvature, to allow the middle bone 41 to be placed along the circular arc portion of the rod-shaped jig 50, and to bend the middle bone 41 while pressing the rod-shaped jig 50. Since the optical fiber 10 is fixed to the middle bone 41 by the first fixing member 20 and the optical fiber fixing portion, as a result, it is possible to manufacture the optical connecting component in which a part of the optical fiber 10 having a desired circular arc shape is bent. The middle bone 41 may be formed in an S shape by applying an external force a plurality of times within a length range of the middle bone 41 in the longitudinal direction and providing the bent portions at a plurality of locations. As described above, in the embodiment, since the middle bone 41 can be bent into a desired shape, a circuit board having a predetermined curved surface or a member having a curved hole is not required.

### Second Embodiment

FIG. 5 is a perspective view illustrating another example of the second fixing member of the optical connecting component of the present disclosure. In the first embodiment, the middle bone 41 of the second fixing member 40 is linearly formed, and the bent portion is formed after fixing the optical fiber 10, and in the embodiment, the second fixing member 40 including the bent portion 44 formed in the middle bone 41 with a predetermined curvature is used. In the embodiment, first, the first fixing member 20 on which the optical fiber 10 is mounted is mounted on the grip portion 42 provided at one end portion of the second fixing member 40, Next, the optical fiber 10 is bent along the bent portion 44 of the middle bone 41, and the optical fiber 10 is fixed to the middle bone 41 by the optical fiber clamp piece 43 at the other end portion of the middle bone 41. In order to fix the optical fiber 10 to the middle bone 41, a separate clip member and an adhesive may be used instead of the optical fiber clamp piece 43. In the embodiment, since the middle bone 41 of the second fixing member 40 can be bent into a desired shape, it is possible to easily obtain the optical connecting component including the middle bone 41 bent into a desired shape without requiring a circuit board having a predetermined curved surface or a member having a curved hole.

### REFERENCE SIGNS LIST

1: optical connecting component

10: optical fiber

11: core

12: clad

13: glass fiber

14: coating layer

20, 30: first fixing member

21: pore

31: V-groove circuit board

32: flat circuit board

33: V-groove

40: second fixing member

41: middle bone (backbone)

42: grip portion

42A: bottom side portion

42B: side wall portion

42C: upper side portion

43: optical fiber damp piece

44: bent portion

50: rod-shaped jig

1. An optical connecting component, comprising:
an optical fiber;
a first fixing member to which one end portion of the optical fiber is fixed; and
a second fixing member including a bendable middle bone, a grip portion for griping the first fixing member on one end side of the middle bone, and an optical fiber fixing portion for fixing the optical fiber to the middle bone on the other end side of the middle bone.

2. The optical connecting component according to claim 1,
wherein the middle bone is bent, and the optical fiber is bent along the middle bone.

3. The optical connecting component according to claim 1,
wherein the first fixing member includes a hole through which the one end portion of the optical fiber penetrates.

4. The optical connecting component according to claim 1,
wherein the first fixing member includes two plate-shaped members that sandwich the one end portion of the optical fiber.

5. The optical connecting component according to claim 1,
wherein the optical fiber fixing portion is a clamp member that is provided on the middle bone and clamps the optical fiber.

6. The optical connecting component according to claim 1,
wherein the optical fiber fixing portion is an adhesive that allows the optical fiber to adhere to the middle bone.

7. The optical connecting component according to claim 1,
wherein the second fixing member is made of plastically deformable steel material.
